(19) United States
(12) Patent Application Publication
(10) Pub. No.: US 2004/0268043 A1
(43) Pub. Date: Dec. 30, 2004

(54) Recording medium, recording apparatus and reproducing apparatus

(75) Inventors: Taku Hoshizawa, Kawasaki (JP); Naozumi Sugimura, Yokohama (JP); Akinobu Watanabe, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/665,661

(22) Filed: Sep. 19, 2003

(30) Foreign Application Priority Data
Jun. 27, 2003 (JP) 2003-183735

(51) Int. Cl. G06F 12/00

(52) U.S. Cl. 711/117

(57) ABSTRACT

A recording medium which records a file for storing writing data as well as file management information for managing the file, wherein main file management information stores, in a file format, sub file management information and sub-file related information. In addition, a recording apparatus in which data is written into the recording medium and a recording medium in which data is reproduced from the recording medium are also disclosed.

### FIELD OF THE INVENTION

The present invention relates to a recording medium which applies a file system that manages data in a file format, a recording apparatus for recording data in the medium and a reproducing apparatus for reproducing data from the medium, and specifically to a recording medium suitable for extending a recording medium, such as an optical disk or a magnetic disk, which applies an AV file system, to a PC file system compatible with the AV file system, a recording apparatus for recording data in the medium and a reproducing apparatus for reproducing data from the medium.

### BACKGROUND OF THE INVENTION

In recording media, such as optical disk apparatuses and magnetic disk apparatuses, data is recorded in a file format to provide easy access to the recorded data file. To manage those data files, a file system is employed.

Not only data but also information concerning files recorded in the recording medium is stored in each recording medium. The information that is or has been stored in the recording medium is called file management information.

A widely used magneto optical disk is a CD-ROM. A CD-ROM generally applies a file system called ISO-9660. The ISO-9660 adopts a table called path table to describe directory structure. The path tables are numbered in sequence, each of which has 16-bit length.

On the other hand, a DVD, being broadly used, is a higher density type of optical disk and applies a file system called UDF (Universal Disc Format). The UDF adopts a file identifier and a file table for each directory to describe directory structure.

Furthermore, for reproducing AV data, such a file system as disclosed in Japanese Application Patent Laid-Open Publication No. Hei 11-312378 (United States Patent Application Publication US 2002/0099722 A1) has so far been devised. The file system disclosed in the publication uses a data managing table, such as a file table, which serves as file management information for managing files. In this file system, tables to be registered are also managed by providing a number of 16 bits in length for each table.

In most conventional file systems, a 16-bit number, from 0 to 65535, is assigned to a table used for file management. This means that only 65,536 types of tables can be created at the maximum and therefore, the number of files and directories that can be managed by the file system is limited up to 65,536.

However, recording capacity of recording media, represented by optical disks and magnetic disks, has been increasing every year with greater number of files to be recorded.

Nevertheless, conventional type file systems have been widely used which are not exactly suitable for utilizing a large-capacity disk.

On the other hand, the use of UDF does not limit the number of tables that can be used and allows a large number of files to be handled. Not all apparatuses support UDF, however.

If the structure of a file system is changed, the compatibility with conventional apparatuses is lost. Therefore, drastic change of the file system must be avoided. Especially, in AV (audio visual) apparatuses such as video disk recorders, it is difficult to change software and it is not possible to reproduce a disk which is incompatible with a conventional file system.

Moreover, in the use for PCs, it is necessary to manage a large number of small files. Usually in recording media such as optical disks, the rewritable unit is relatively large, which could result in the waste of a recording area when a small file is recorded.

### SUMMARY OF THE INVENTION

In general, in one aspect, the present invention relates to a recording medium which records a file for storing write data and file management information to manage the file.

The recording medium records first file management information for managing first file and second file management information for managing second file. Each of said first file management information and said second file management information consists of at least a table for storing information indicating the file name and another table for storing information indicating the recording area of the file, and said first file management information includes management information for managing said second file management information.

In general, in one aspect, the present invention relates to a recording medium which records a file for storing write data and file management information to manage the file, wherein the recording medium records first file management information for managing first file and second file management information for managing second file, each of said first file management information and said second file management information consists of at least a table for storing information indicating the file name and another table for storing information indicating the recording area of the file, and said first file management information includes management information for managing said second file as a file.

In general, in one aspect, the present invention relates to a recording apparatus wherein whether data is written into said first file or said second file stored in said recording medium can be chosen according to the type of data to be recorded.

In general, in one aspect, the present invention relates to a reproducing apparatus which reads out and reproduces data from said first file and/or said second file located in said recording medium.

A Similar file management method and a file system are disclosed in U.S. Patent Application P10/301,067, filed on November 20, 2002, by some of the same inventors.

Other aspects and advantages of the invention will be apparent from the following description and the appended claims.

### BRIEF DESCRIPTION OF THE DRAWINGS

FIG. 1 is a sectional view or a structure diagram of a recording medium, according to one embodiment of the present invention, which records file management information.

FIG. 2 illustrates a data unit structure of well-known sector data.

FIG. 3 illustrates a data structure of the well-known ECC block.

FIG. 4 illustrates a structure of main file management information used for one embodiment of the present invention.

FIG. 5 illustrates the structure of sub file management information used for one embodiment of the present invention.

FIG. 6 is a block diagram of a data recording and reproducing apparatus used for one embodiment of the present invention.

FIG. 7 is a sectional view or a block diagram of a recording medium, according to one embodiment of the present invention, which records file management information.

FIG. 8 illustrates an allocation method of sub file management information used for one embodiment of the present invention.

FIG. 9 illustrates an allocation method of another sub file management information used for one embodiment of the present invention.

FIG. 10 is a sectional view or a structure diagram of a recording medium, according to one embodiment of the present invention, which shows a method to access sub file management information.

FIG. 11 is a sectional view or a structure diagram of a recording medium, according to one embodiment of the present invention, which shows another method to access sub file management information.

FIG. 12 is a sectional view or a structure diagram of a recording medium, according to one embodiment of the present invention, which shows a method to manage the sub file system.

FIG. 13 is a sectional view or a structure diagram of a recording medium, according to one embodiment of the present invention, which shows another method to manage the sub file system.

### DETAILED DESCRIPTION

Referring now to the drawings wherein like reference numbers are used for like parts throughout the several views, various exemplary embodiments of the invention are explained in detail as follows:

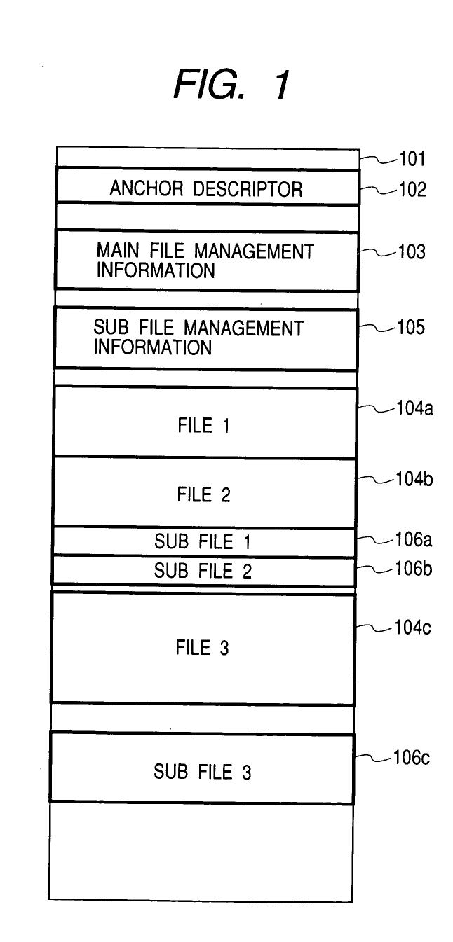

FIG. 1 shows the allocation of file management information and files recorded on the optical disk according to one embodiment of the present invention.

In FIG. 1, reference number 101 represents the recording area of an optical disk, 102 an anchor information or descriptor, 103 main file management information, 104 a file directly managed by the main file management information, 105 sub file management information, and 106 a sub file managed by the sub file management information.

In this embodiment, there are three files that are directly managed by main file management information and three sub files that are managed by sub file management information.

The recording area 101 of the optical disk has a sector structure of the predetermined length, and each sector is capable of recording 2,048 bytes of data. Furthermore, a sector number is sequentially assigned to each of those sectors starting from the center part of the disk, and it is possible to specify a sector to be accessed by referring to the sector number.

The anchor descriptor indicates the area where main file management information is recorded. When the location of the main file managing area is changed, it is possible to change the reading position in the main file managing area by rewriting the anchor descriptor.

When multiple anchor descriptors have been recorded in the anchor descriptor recording area, it is also possible to specify the reference only to the backmost anchor descriptor, thereby reducing the number of rewrites in the anchor descriptor recording area.

The main file management information is an area for managing information, such as the recording position of the data file recorded on the optical disk, size of the data and file identifier (file name).

A file is a data file that has been recorded by user.

The sub file management information is an area for managing sub file information, and the sub file management information and sub files are considered to be a part of the main file in the main file system.

Data recorded on a disk must be accurately reproduced even though smudges or scratches may be present on the disk. For this purpose, as is generally known, an error detection code and error correction code are added to data before the data is recorded on the disk, so that errors can be detected and corrected. To do so, each sector data is converted into a unit data format, and then an error correction code is added to batches of unit data.

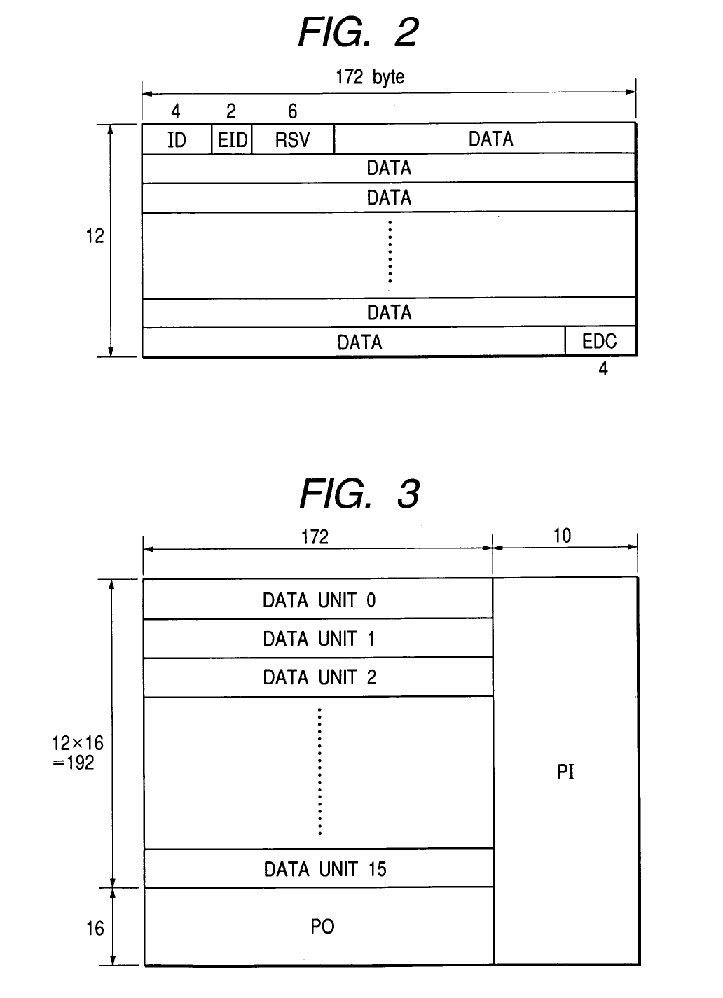

FIG. 2 shows the unit data structuring method.

Each sector has a 2,048-byte data area in which sector data is recorded. The 4-byte data identification code (ID) for identifying data, 2-byte IED which is an ID error detection code, and 6-byte RSV which is a reserve data area are added to the sector data. The 4-byte error detection code EDC for detecting data error is added to the backmost part of the recording data. As a result, a data unit consists of a total of 2,064 bytes of data. Each unit data is handled in a 172-byte, 12-line data format.

FIG. 3 shows the structuring method of the well-known ECC (Error Correcting Code or Error Checking and Correcting) block.

Sixteen sectors of the 172-byte, 12-line unit data, as shown in FIG. 2, are collected to form an ECC block. In the vertical direction, the 16-byte error correction code (PO) is added to each column. Each column consists of 208 lines of data where the 16-byte error correction code is added to 192 lines of data (i.e. 12 lines multiplied by 16 units).

The 10-byte error correction code (PI) is added to the data in each column, which results in 182 bytes of data. Eventually, 182 bytes and 208 lines of data is recorded on the optical disk.

Herein, the CRC code (Cyclic Redundancy Check Code) can be used as an error detection code. And, the Reed-Solomon code (RS code) can be used as an error correction code.

If data is recorded on an optical disk by means of the above-mentioned processing, it is possible to reproduce correct data even when smudges or scratches on the disk prevent some data from being read out.

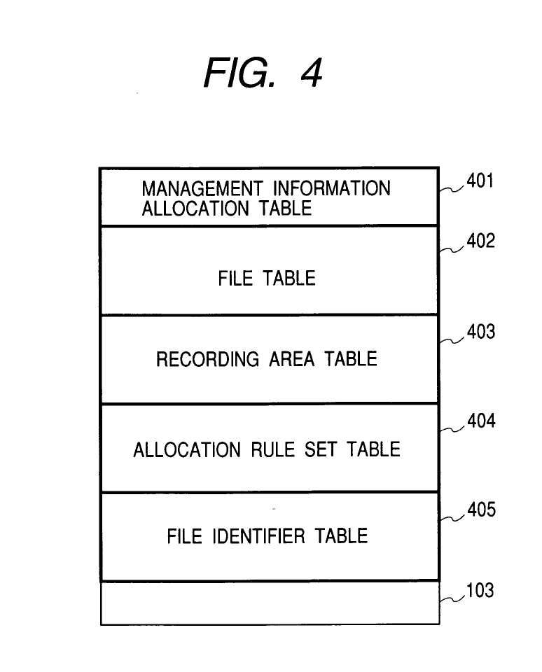

FIG. 4 shows the details of the main file management information used for one embodiment of the present invention.

In FIG. 4, reference number 401 represents a management information allocation table, 402 a file table, 403 a recording area or region table, 404 an allocation rule set table, and 405 a file identifier or name table.

The management information allocation table 401 records information about the allocation of tables located in the file management information. Specifically, this information includes each table's recording start number, the presence or absence of the following table, or the following table's number. This allocation information makes it possible to refer to the content of each table.

The file table 402 includes information such as a file-identifier table number that corresponds to each file, link information indicating directory relationships, file attribute, extension attribute information table number, file type, file creation time, and file revision time. Referring to the file table makes it possible to obtain a table number that corresponds to each file located in each table.

The recording area table 403 records information about the recording position of each file located on the disk. Specifically, the information includes the file's recording start sector number, recording start position, recording end sector number, and recording end position. When data in a file is read out, the sector number in which the data is recorded is obtained from the recording area table and then the data is read out.

The allocation rule set table 404 records information concerning the division and allocation of the data located on the disk. This specifies the minimum size of the divided data when the data is recorded on the disk so that data can be continuously read. For example, when continuously using sectors by 4,096-sector (8 MB) batch, the value 4,096 is set as a parameter.

The file identifier table 405 contains information concerning the name and length of the file identifier. Assuming that a single file identifier table is 32 bytes, if 4 bytes are allocated to the file identifier length, the 28-byte data area can be allocated to the file identifier entity.

Moreover, each of the above-mentioned tables consists of 32 bytes. If a recording area is insufficient, it is possible to extend the length of the recording data by using multiple tables.

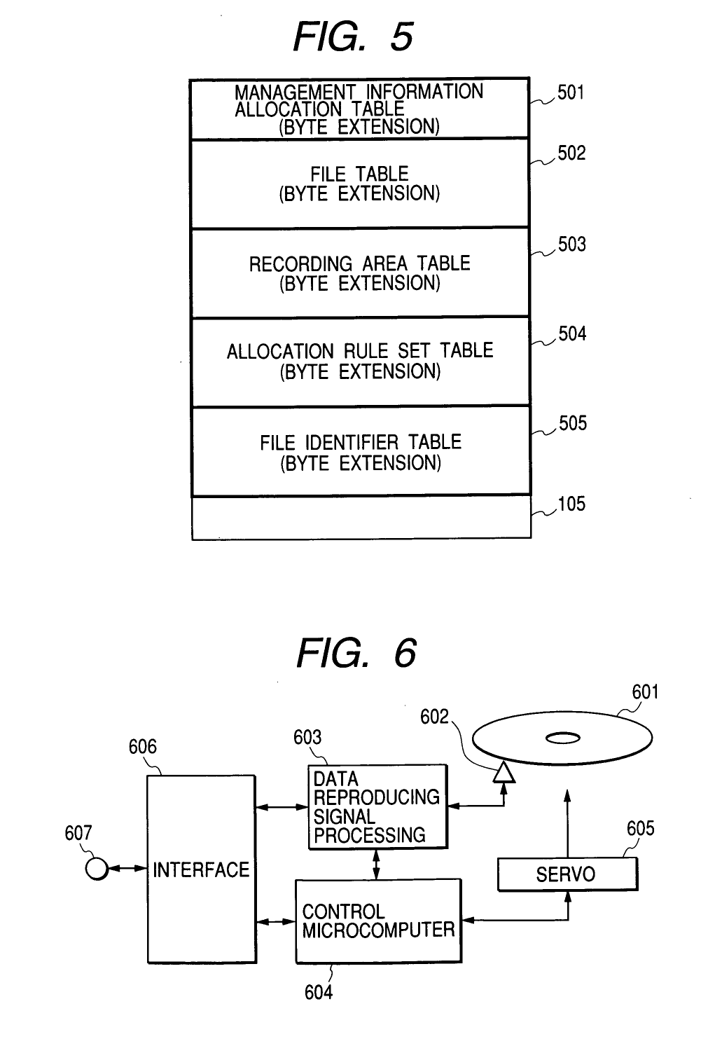

FIG. 5 shows the details of the sub file management information used for one embodiment of the present invention.

In FIG. 5, reference number 501 represents a byte-extended management information allocation table, 502 a byte-extension file table, 503 a byte-extension recording area or region table, 504 a byte-extension allocation rule set table, and 505 a byte-extension file identifier table.

Those tables are all the same as the tables shown in FIG. 4 except that the number of bytes used for management numbers of those tables shown in FIG. 5 has been extended.

The number of bytes can be extended by increasing the number of bits that are allocated for managing each table. For example, if 16 bits are allocated for the management number of the main file management information table, 32 bits will be allocated for the table management number of each table located in the sub file management information.

The sub file management information 105 consisting of byte-extended tables as well as recorded sub files 106 are managed as a single file in the main file management information 106 by allocating the area where sub file management information and sub files have been recorded as if the area were a single file in the main file management information.

FIG. 6 is a block diagram of the recording and reproducing apparatus used for one embodiment of the present invention.

In FIG. 6, reference number 601 represents an optical disk, 602 an optical head or pick-up, 603 a signal processing circuit, 604 a control microcomputer, 605 a servo, 606 an interface, and 607 an input/output terminal.

Information recorded on the optical disk 601 is read out by the optical pick-up 602 and demodulated by the signal processing circuit 603. The demodulated data will be decrypted by means of error correction processing or the like, and then sector data will be outputted to an external host PC (not shown) or the like via the interface 606 and the input/output terminal 607. The control microcomputer 604 receives a command from the external host PC on the like and controls the entire apparatus so that access to a specified sector can be performed.

While recording, sector data is inputted from an external host PC via the input/output terminal 607 and the interface 606. The inputted data is encoded by the signal processing circuit 603 adding the error correction code, and then modulated in such a manner that the data can be written to an optical disk, and finally written to the optical disk 601 via the optical head 602. The control microcomputer 604 receives a command from an external host PC or the like and controls the entire apparatus so that data can be written into a specified sector.

Moreover, the servo 605 controls the rotation of the optical disk and the tracking of the optical pick-up according to the instructions provided by the control microcomputer 604.

Now, by using an example of an apparatus that is not compatible with sub file information but is compatible with main file management information only, the file reading operation will be described.

When an optical disk 601 is inserted into a disk drive, the control microcomputer 604 detects the inserted disk and notifies the host PC via the interface 606 and input/output terminal 607 that the disk has been inserted.

When the host PC is notified that the disk has been inserted, it first instructs to read the anchor descriptor 102. The anchor descriptor 102 has the sector number in which main file management information 103 has been written.

The host PC, based on the read-out anchor descriptor 102, searches the sector number in which main file management information 103 has been recorded in order to read the main file management information.

In the main file management information 103, all information about the main file, such as main file identifier, recording position, and directory structure, has been recorded as tables.

For reading a predetermined file by using the main file management information, as shown in FIG. 4, the management information allocation table 401 is first read out. All file tables 402 for recorded files are searched from the data in the management information allocation table 401. Each file table 402 has a file-identifier table number which corresponds to the file table; therefore, a file table with a file-identifier table number that is identical to the name of the file to be read is searched. At this point, a directory is also analyzed based on the directory structure information written to the file table so as to find a desired file table.

After the file table 402 has been searched, the sector number in which a file to be read has been recorded as well as the number of recorded bytes can be obtained from the recording area information located in the recording area table 403 that corresponds to the file table. Based on this information, data is read from the optical disk information sector.

In one embodiment of the present invention, data (105 and 106) managed by the sub file system has been recorded as a group of files. That is, data managed by the sub file system is considered as a single file and given a name, and the information on the recording position and data length is recorded. Herein, an example uses a SUBFILES.SYS as a file name to provide an explanation below.

It is treated as if the main file management information 103 includes a file named SUBFILES.SYS in addition to files managed by the main file system.

This file name must have a file identifier that is not usually used in the main file system. Actually, the file identifier can have any name, however, the name should not be confused with a name in the main file system.

Furthermore, the SUBFILES.SYS is treated as a file that is segmented and allocated on the disk, and recording positions of sub file management information and sub files 1, 2, and 3 are registered as the recording position of this file. The sum of the lengths of all the data is used as the data length of this file.

In an apparatus that is compatible with only main file management information 103, access to the SUBFILES.SYS does not usually occur, which means that access to the sub file area does not occur. Therefore, there is no possibility that an access made in error will delete data, or will cause any effect to the main file system. Accordingly, in an apparatus that is compatible with only main file management information, files other than the SUBFILES.SYS can be normally accessed.

Furthermore, the sub file 106 and the sub file management information 105 have been recorded independently from the main file system; therefore, data in the main file system is not affected at all.

In an apparatus that is compatible with main file management information, if an error occurs when data managed by sub file management information is accessed, the problem can be avoided by adding attribute information, such as “write inhibit”, “read inhibit”, or “hidden file,” to the SUBFILES.SYS file in the main file management information as needed. Or, since the SUBFILES.SYS is a special file that has a sub file system, it is possible to add a flag as attribute information to the file attribute area of the main file management information file table 402. In addition, some other methods can be considered as well. For example, it is also possible to store the SUBFILES.SYS file in a special directory.

As stated above, in a file system according to one embodiment of the present invention, it is possible to access the main file system without causing any effects on the sub file system. Thus, it can be said that the file system has excellent downward compatibility with the main file system.

Next, the sub-file access operation of an apparatus that is compatible with the sub file information as well will be described.

In an apparatus that is compatible with the sub file system as well, information about SUBFILES.SYS, such as the recording position and the data length, is first obtained by using the main file system. This process is the same as the file search process conducted by the above-mentioned apparatus that is compatible with only main file management information.

In an example shown in FIG. 1, the recording position of the sub file management information 105 is at the top of the recording position of SUBFILES.SYS. Therefore, data is read from the recording start position of the SUBFILES.SYS and the data is analyzed as part of the sub file management information.

First, a byte-extension management information allocation table 501 is read out. All file tables (byte extension) 502 for recorded files are searched from the data contained in the management information allocation table. Each file table 502 has a file-identifier table number which corresponds to the file table; therefore, a file-identifier table number that is identical to the name of the file to be read is searched. At this point, a directory is also analyzed based on the directory structure information written on the file table so as to find a desired file table.

After the file table (byte extension) 502 has been searched, the sector number in which a file to be read has been recorded as well as the number of recorded bytes can be obtained from the recording area information contained in the recording area table (byte extension) 503 that corresponds to the file table. Based on the information, the host PC reads the data file recorded in the sub file area.

As a result of the above-mentioned processing, it is possible to access the file located in the sub file area. At this point, sub file management information and sub data files located in the sub file area have been written in the area that corresponds to the SUBFILES.SYS. Therefore, once the SUBFILES.SYS has been accessed, it is not necessary at all to access main file management information 103 or the main file 104 located in the main file system, which means that the operation is completed within the sub file system. Consequently, the main file system is not affected and the independence of the sub file system can be maintained.

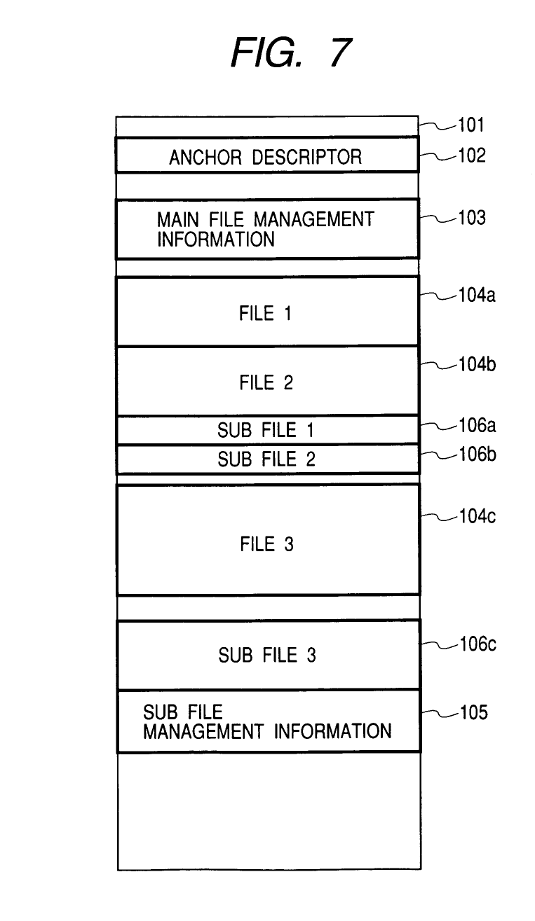

Next, an explanation about the recording position of sub file management information 105 will be provided with reference to FIG. 1 and FIG. 7.

In FIG. 1, the sub file management information 105 is allocated immediately after main file management information 103 on the disk.

This allocation is effective when a sufficient area for the sub file management information 105 is beforehand secured on the disk the same as the area for the main file management information 103.

However, because table management numbers of the tables located in the sub file management information 105 have been extended, the length of the tables may become significantly long according to the number of sub files when compared to the length of the tables located in the conventional main file management information. Considering this aspect, it is expected that securing beforehand an area for sub file management information may be difficult. In such a case, as shown in FIG. 7, an effective method is to allocate sub file management information 105 immediately after the sub file 106 has been recorded last of all.

Next, an explanation will be provided about the processing through which a sub file is added to the area managed by the sub file management information in this allocation.

To add a sub file to the sub file area, a vacant area on the disk is first detected by using the main file management information 103 and the file data is written to the disk. Specifically, it is sufficient to read out the recording area table 403 that corresponds to all files located in the main file management information and check the used area on the disk based on the read-out table.

To add a sub file, it is sufficient to simply add data after the sub file area. If there is no vacant area after the sub file area, data discontinuity will occur, however, it does not cause a problem.

Herein, the size of the sub file area increases by the capacity of the added sub file data. The increase is reflected as an increase of the SUBFILES.SYS file in the main file management information.

Even if sub file data is not recorded in the contiguous areas but randomly located, separate recording is made possible by allocating multiple recording areas in the main file management information recording area table which corresponds to the recording area of the SUBFILES.SYS.

However, if a recording area is randomly segmented, it takes time to search data before reading the data from an optical disk because the read-out sector frequently changes. To avoid this problem, a more effective procedure is to secure a sizable capacity of a recording area on the disk and write data in the contiguous sectors located in the area. For example, allocating nearly 8 MB is sufficient for the recording area. Information about the contiguously written data's length is written into the allocation rule set table 404 located in the main file management information.

It is possible to access sub files by adding information about the recorded sub file, such as file name, data recording position and data length, to the byte-extension file table 502, recording area table (byte extension) 503, and file identifier table (byte extension) 505 located in the sub file management information 105.

As a result of the above-mentioned processing, a file is added to the sub file management information. At the same time, the recording area information is updated in the main file management information. Therefore, even in an apparatus that uses only main file management information only, inconsistency is avoided.

Furthermore, even if the size of the sub file area is reduced due to the deletion of a sub file, if main file management information is rewritten such that the size of the SUBFILES.SYS file has changed, inconsistency will be avoided in both file systems.

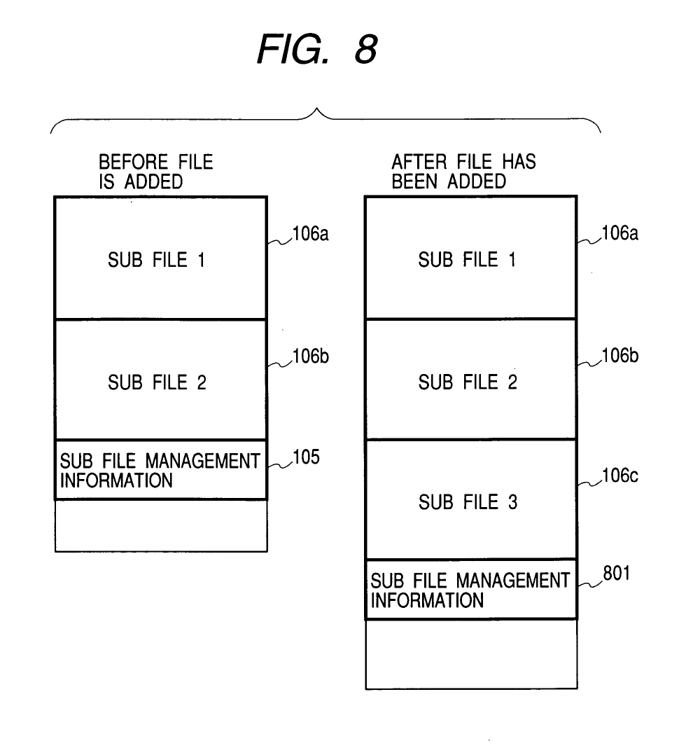

FIG. 8 shows a recording method for recording sub file management information in the backmost part of the sub file area. Herein, reference number 801 represents updated new sub file management information.

In the sub file management information recording method shown in FIG. 1, sub file management information 105 is recorded at the head of the sub file area. However, this method fixes the writing position in the sub file managing area, which results in the following problems.

That is, because the writing position of the sub file management information is located before a sub file 106, the sub file management information writing area is limited. Therefore, if a large number of sub files are added, the sub file management information recording area may become insufficient. Furthermore, every time sub file management information changes, the sub file management information area has to be rewritten, causing the number of rewrites to increase and resulting in shortening the life of the disk.

To avoid this problem, in the sub file management information recording method shown in FIG. 7, sub file management information 105 is allocated after the recording area of the sub file 106. To add a file, as shown in FIG. 8, an additional file (106c) is overwritten in the area where the sub file management information has been written, and new file management information 801 is written in an area after the added file. By doing so, the area in which sub file management information is written will not be limited. Furthermore, the sub file management information recording area changes every time a file is added, which prevents the data writing operation from concentrating within specific sectors.

In addition, another advantage can be obtained by placing the sub file management information recording start position at the backmost part of the sub file recording area. The advantage is to facilitate an additional write operation to an optical disk called Write Once which can record data only once.

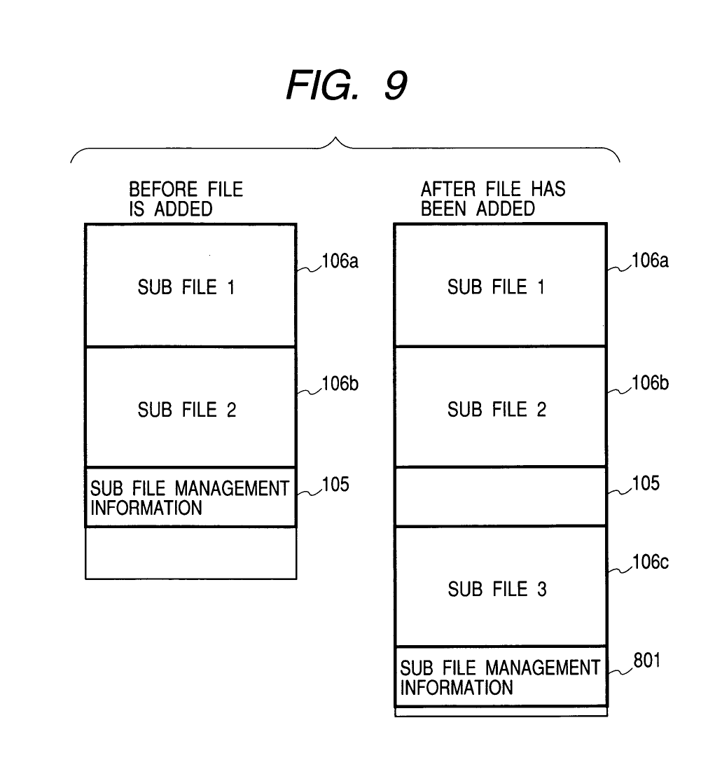

FIG. 9 shows the change of the sub file recording area before and after a file is added.

Once data has been written to a Write-Once type disk, it is not possible to delete the data. Therefore, a rewrite of the data is performed through an additional write process. Furthermore, the additional write is performed in each ECC block.

In FIG. 9, the written sub file 3 (106c) is added after the old sub file management information 105. At this point, the old sub file management information is made impossible to use by specifying the sub file management information recording start position to be at the backmost part of the sub file recording area. By adding information on the sub file 3 to the old sub file management information, creating new sub file management information 801 and recording it after the sub file 3, it is possible to automatically refer to the new sub file management information.

However, because the size of the sub file recording area has increased, it is necessary to change main file management information as if the size of the SUBFILES.SYS had increased.

As stated above, introduction of the sub file system enables access to sub files and addition of sub files. By doing so, there is no effect on the main file system, and therefore, there is no problem of the compatibility with conventional file systems.

In the above-mentioned embodiment, sub file management information and sub files are treated as a single main file; however, other variations are available. For example, it is also possible to specify sub file management information as an independent main file and specify sub files usually consisting of multiple files as another single main file. In this case, although those files are treated as two different files in the main file management information, the effect is the same.

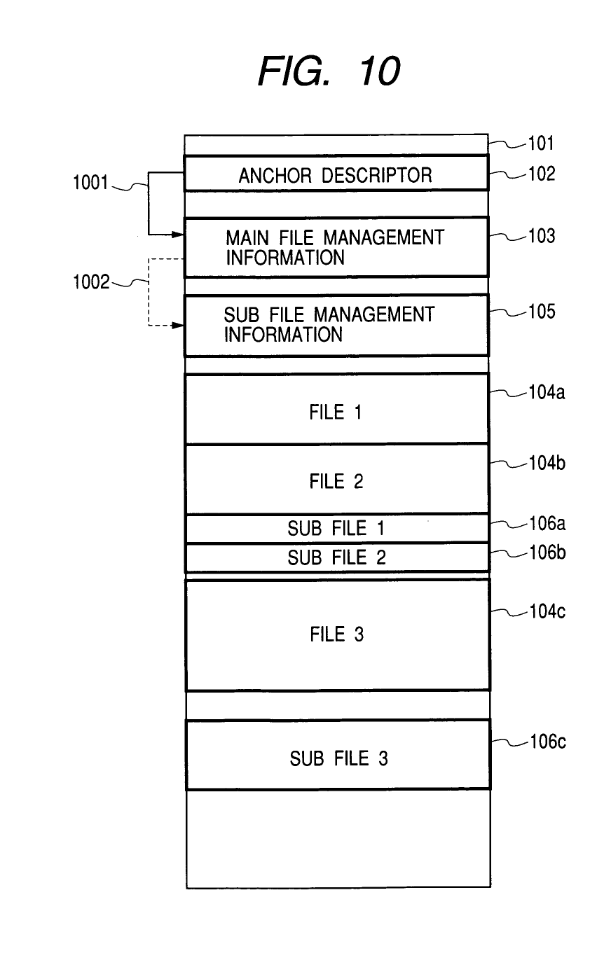

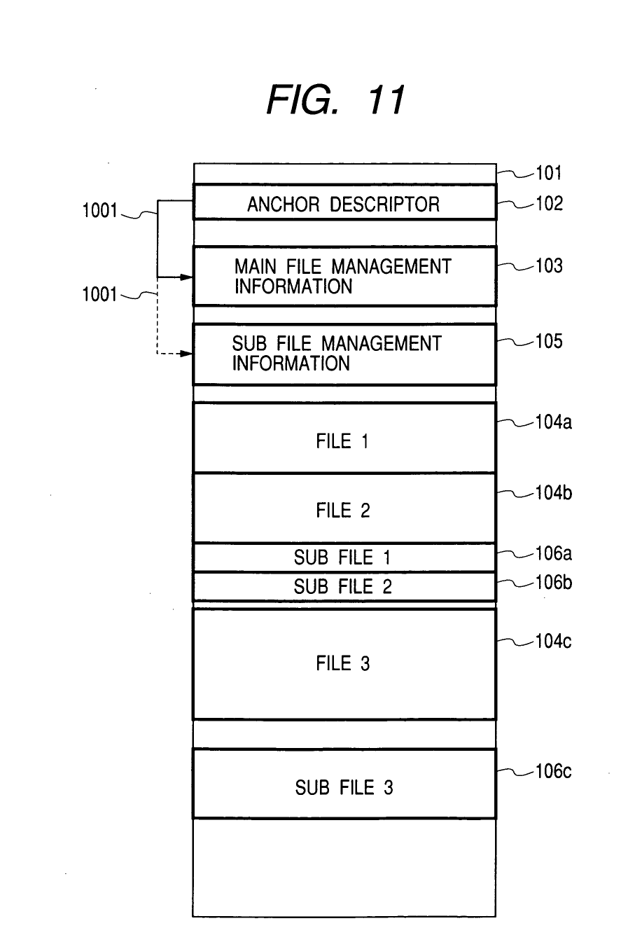

FIG. 10 and FIG. 11 are a sectional view or a structure diagram of a recording medium, such as an optical disk, according to one embodiment of the present invention. Those drawings show the method for searching the above-mentioned sub file management information 105.

In FIG. 10, the solid-line arrow 1001 indicates that the location of main file management information 103 can be identified from the anchor descriptor 102. The broken-line arrow 1002 indicates that the location of sub file management information can be identified from the main file management information 103.

As explained with reference to FIG. 1, the recording position of the sub file system coincides with the recording position of one file, like SUBFILES.SYS, which virtually indicates a sub file in the main file management information 103. Therefore, by allocating sub file management information 105 in a specific location in the sub file system, for example, at the head of the sub file system; sub file management information is referred to via the main file management information.

FIG. 11 explains a case when, in main file management information 103, the location of the sub file system consisting of sub file management information and sub files can be recognized, as shown in FIG. 10, but the recording position of the sub file management information 105 cannot be identified. In this drawing, the solid-line arrow 1001 indicates that the location of the main file management information 103 can be identified from the anchor descriptor 102, and the broken-line arrow 1101 indicates that the location of the sub file management information 105 can also be identified from the anchor descriptor 102.

In this case, because information included in the anchor descriptor 102 is extended, there may be a problem with the compatibility. However, the anchor descriptor 102 includes a reserve area which is not referred to when data is reproduced in an apparatus that is incompatible with the sub file system. Therefore, it is possible to extend the sub file system while maintaining the compatibility with all types of apparatuses by recording information about the recording position of sub file management information 105 in the reserve area of the anchor descriptor 102 as in the same manner as the information about the recording position of the main file management information 103.

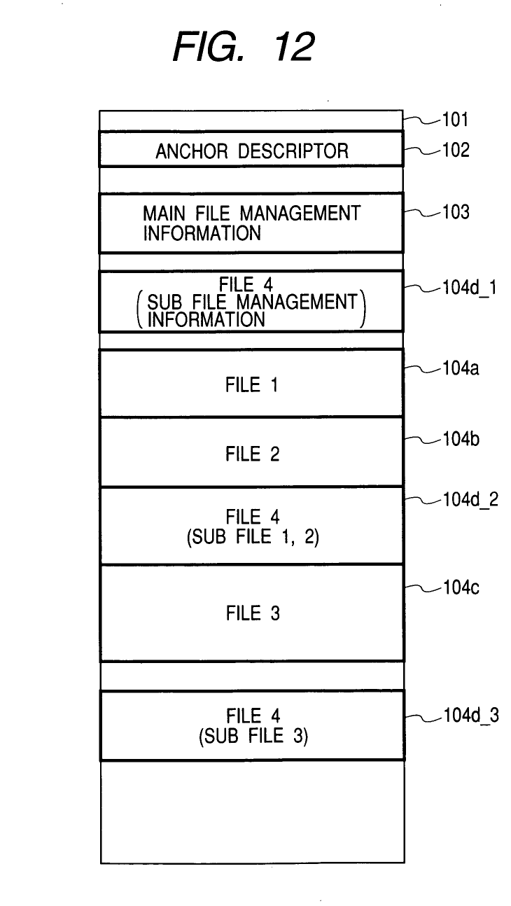

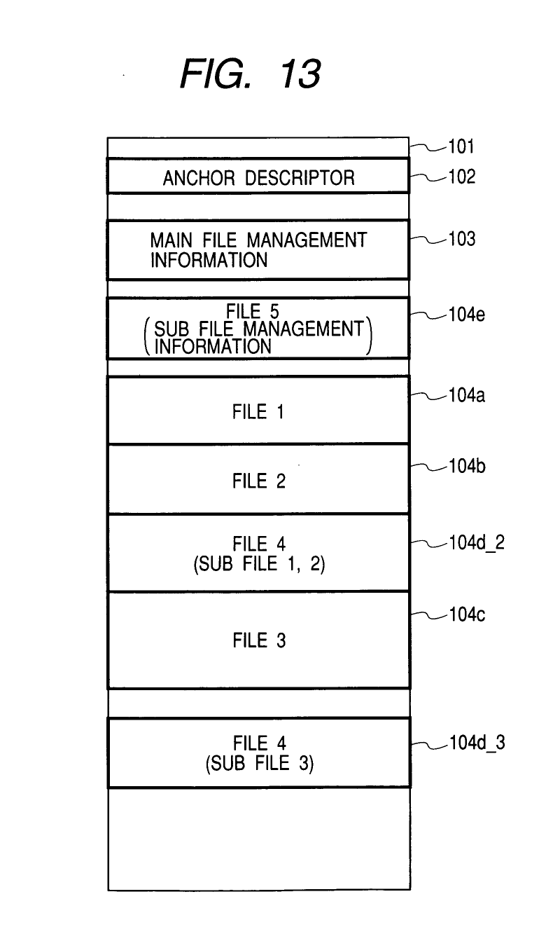

FIG. 12 and FIG. 13 are a sectional view or a block diagram of a recording medium, such as an optical disk, according to one embodiment of the present invention. Those drawings show the method for managing the above-mentioned sub file system consisting of the sub file management information 105 and sub files 106 in the main file system.

In FIG. 12, all files located in the sub file system are shown as file 4 (104d-1, d-2, d-3). This means that all files related to sub files are treated as a single file in the main file management information.

In FIG. 13, sub file management information is shown as file 5 (104e) and sub files are shown as file 4 (104d-2, d-3). In a system that searches sub file management information 105, shown in FIG. 10, via main file management information 103; if the allocation of the sub file management information 105 can be uniquely fixed in the sub file system, it is possible to manage the sub file system shown in FIG. 12 as a single file.

However, the allocation of the sub file management information 105 cannot be fixed in the sub file system, the sub file management information 105 is separately made independent of other sub files, and given an own address of the sub file management information 105 in the recording area table 403 included in the main file management information 103. By doing so, it is possible to access the sub file management information 105 from the main file management information 103.

Advantages derived from the present invention may include one or more of the following.

According to one or more embodiments of the present invention, it is possible to provide a new file system that can manage a larger number of files while maintaining compatibility with conventional file systems.

According to one or more embodiments of the present invention, an apparatus stores not only main file management information but also sub file management information, thereby being capable of managing more files than the case where main file management information is used only.

According to one or more embodiments of the present invention, because the sub file system is treated as a file in the main file system, the structure of the main file system is not affected thereby resulting in excellent compatibility.

According to one or more embodiments of the present invention, even when many small files exist as sub files, those files are treated as a single file, which prevents the recording area from being wasted.

While the invention has been described with respect to a limited number of embodiments, those skilled in the art, having benefit of this disclosure, will appreciate that other embodiments can be devised which do not depart from the scope of the invention as described herein. Accordingly, the scope of the invention should be limited only by the attached claims.

What is claimed is:

1. A recording medium in which a file for storing write data and file management information for managing the file have been recorded, wherein
said file management information comprises, first file management information for managing first file and second file management information for managing second file;
each of said first file management information and said second file management information consists of at least a table for storing information indicating the file name and another table for storing information indicating the recording area of the file; and
said first file management information includes management information for managing said second file management information.

2. A recording medium according to claim 1, wherein
the number of files managed in said second file management information is greater than the number of files managed in said first file management information.

3. A recording medium according to claim 1, wherein
said first file management information includes attribute information that indicates said first file and said second file management information.

4. A recording medium according to claim 3, wherein
said attribute information includes file name or file management information name.

5. A recording medium according to claim 1, wherein
management information that manages said second file management information is a recording area of said second file management information.

6. A recording medium according to claim 1, wherein
said first file management information includes management information that manages said second file management information and said second file as a single file.

7. A recording medium in which a file for storing write data and file management information for managing the file have been recorded, wherein
said file management information comprises, first file management information for managing first file and second file management information for managing second file;
each of said first file management information and said second file management information consists of at least a table for storing information indicating the file name and another table for storing information indicating the recording area of the file, and
said first file management information includes management information for managing said second file as a file.

8. A recording medium according to claim 7, wherein
the number of files managed in said second file management information is greater than the number of files managed in said first file management information.

9. A recording medium according to claim 7, wherein
said first file management information includes management information that manages said second file management information as a different file.

10. A recording medium according to claim 1 or 7, wherein
an anchor descriptor indicating the recording area of said first file management information has been recorded.

11. A recording medium according to claim 1 or 7, wherein
an anchor descriptor indicating the recording area of said first file management information and said second file management information has been recorded.

12. A recording apparatus wherein
whether data is written into said first file or said second file stored in a recording medium, according to any one of claims 1 through 9, can be chosen according to the type of data to be recorded.

13. A recording apparatus wherein
AV file information has been written and recorded in said first file stored in a recording medium according to claim 1 or 9 and PC file information has been written and recorded in said second file.

14. A reproducing apparatus for reading out and reproducing data from said first file or said second file stored in a recording medium according to any one of claims 1 through 9.
